(19) United States
(12) Patent Application Publication
(10) Pub. No.: US 2013/0030953 A1
(43) Pub. Date: Jan. 31, 2013

(54) Multimedia System for Shopping Process Management

(71) Applicant: Ivana Marsic, Zagreb (HR)

(72) Inventor: Ivana Marsic, Zagreb (HR)

(21) Appl. No.: 13/574,580

(22) PCT Filed: Jan. 20, 2010
(86) PCT No.: PCT/HR10/00001

§ 371 Date: Oct. 15, 2012

(51) Int. Cl. G06Q 30/00

(52) U.S. Cl. 705/26.7

(57) ABSTRACT

There are problems in retail chains and stores directly affecting the sales volume and business results: —sales items are not visible enough on the store shelves, —other items, matching the ones the customer is looking for, are insufficiently noticed, —there is not enough personalised approach, —customers cannot find adequate items by themselves, —customers have no record of the items bought, especially record of purchases through various retails chains, —customers are reluctant, and—the sales increase potential is not focused on the point of shopping i.e. stores, but rather on Internet sales. Yet, most shopping decisions are made in stores, and not on the Internet. These problems are solved by the multimedia system for shopping process management (300) that utilises hardware and software components. The hardware component comprises client computers, touch-screen monitors, server computers, barcode/RFID readers, Bluetooth transmitters, built in cameras, store-personnel mobile devices, and store-personnel mobile devices with built in scanning/RFID reading feature. The software framework together with hardware components provides a platform for miming software applications i.e. various multimedia services integrated with mobile devices and other IT systems. The multimedia system for shopping process management is implemented through the following activities: —ACTIVITY A—suggesting additional sales items and transferring information/requests to the store personnel; —ACTIVITY B—integration of loyalty cards with the multimedia system or introduction of unique loyalty cards intended exclusively for the multimedia system; and—ACTIVITY C—introduction of the customer 3D models.

### 1. FIELD OF APPLICATION

The invention relates to a multimedia system aimed at enhancing the shopping process, enabling its business users—retail stores and chains to boost their sales significantly, providing an innovative and entertaining service to end users—customers/shoppers increasing the customer satisfaction and brand loyalty.

In the International Patent Classification, it is classified as Section H—Electricity, Class H04—Electronic Communication Technique, Subclasses H 04 J—Multiplex Communication, and H 04 N—Pictorial Communication; as well as Section G—Physics.

### 2. TECHNICAL PROBLEM

In retail chains and individual stores some problems have been noticed that directly affect the volume of sales and business results, such as:
sales items are often not visible enough on the store shelves,
other items, matching the ones the customer is looking for, are not noticed,
customers do not like being addressed by the store personnel or are reluctant about asking themselves,
customers often cannot find adequate items by themselves,
customers have no record of the items bought,
customers are indecisive,
store personnel are not fully familiar with the customers and their wishes,
there are missed additional sales opportunities,
the existing IT—information technology systems provide limited feedback on the customers' behaviour and wishes and gather no information during the pre-sales process,
the sales increase potential is more focused on Internet sales than in-store sales.

Yet, most shopping decisions are made in the store, and not on the Internet.

The technical problem solved by this invention relates to defining the systems, processes, and methods for boosting the sales of the merchandize in stores and retail chains, integrating the Internet and the in-store sales, as well as enhancing the overall sales management process, cutting the operative costs and increasing the efficiency.

### 3. STATE OF THE ART

Here are the solutions that are presently implemented at stores and retail chains:

Virtual wardrobe is an Internet service enabling customers to try the garments virtually. It focuses on Internet sales rather than the place of sales, i.e., store.

Virtual promoter utilises touch-screens, combined with a web camera located in front of the store. A sensor detects the customers passing by and activates the Virtual Promoter—a true or 3D image that begins conversation with customers inviting them into the store.

Interactive dressing room with camera is a technology enabled dressing room, partly transparent, with a camera showing various angles of the customer and the garment enabling the store personnel to fully focus on the customer. Store personnel uses devices for item label scanning and checking the availability of the item on the stock, etc.

This indicates there are needs for introduction of new shopping methods and processes that will position customer in the centre of the retail process.

### 4. DISCLOSURE OF THE INVENTION

The essence of the invention is a multimedia system for shopping process management including hardware and software components. The hardware component comprises client computers, touch-screen monitors, server computers, barcode/RFID readers, Bluetooth transmitters, built in cameras, store-personnel mobile devices, and store-personnel mobile devices with built in scanning/RFID reading feature. Hardware components such as client computers, touch-screen monitors, barcode/RFID readers, Bluetooth transmitters, cameras are placed inside the store (both inside the lobby of the store and inside dressing rooms). The software framework together with hardware components provides a platform for running software applications i.e. various multimedia services integrated with mobile devices and other IT—information technology systems.

The multimedia system for shopping process management is implemented through the following activities:
ACTIVITY A—suggesting additional sales items and transferring information/requests to the store personnel;
ACTIVITY B—integration of the customer loyalty cards with the multimedia system or introduction of unique loyalty cards intended exclusively for the multimedia system; and
ACTIVITY C—introduction of the customer 3D models.

Activity B represents the functional upgrade of Activity A while Activity C represents the functional upgrade of Activity B.

The hardware devices are mutually linked and software supported, to enable:
personalised approach to shopping,
visually attractive multimedia presentation of the merchandise,
review of additional items that can be combined with the initially selected one, and the possibility of their selection by the customer,
reading the selected item's barcode or RFID,
presenting 3D images of all sales items,
providing the store personnel with the information on the item sought (size, colour, code, image, etc.) at their mobile phone devices or smart phone devices, which enhances efficiency of the store personnel engagement,
integration with the existing customer loyalty card system or introduction of unique customer loyalty cards intended exclusively for the multimedia system,
scanning or reading the customer loyalty cards in store and integrating with the multimedia system functionality,
input and definition of items matching the initially selected one by the retail chain or store, hence utilizing the multimedia system to exploit the store-personnel current knowledge related to particular customers, collections and items,
Internet application intended for loyal customers, providing the customer's complete profile, shopping history, orders, reservations, defining preferences and wishes, matching items, reviewing collections prior to their order from the retailer,
introduction of the customers 3D images obtained by 3D laser scanning,
tracking of all transactions generated through the multimedia system,
introduction of new charging method by deploying special transaction fees based on sales made through the multimedia system,
unique data transfer method and communication among elements of the multimedia system and elements of the other systems,
upgrading the multimedia system functionality to a mobile platform,
gathering pre-sales data and integrating pre-sales and sales data,
providing the customer with a personalised service that enables tracking all purchases and spending across different retail chains and stores and controlling budget and consumption,
specific item search system, and
data flow monitoring, statistics and reporting.

The multimedia system for shopping process management may be introduced in several ways:
without the integration with the loyalty card system
through the introduction of unique loyalty card system related to the multimedia system only
through the integration of existing loyalty card system with the multimedia system.

Compared to the existing solutions implemented at retail chains or stores, the multimedia system for shopping process management focuses on a business niche improving the customer satisfaction and providing a new shopping management system with sophisticated business analysis complementary with the existing business intelligence and customer relationship management systems.

Hereafter, the expression multimedia system for shopping process management 300 will be referred to shortly as the multimedia system 300.

### 5. ILLUSTRATION DESCRIPTIONS

The accompanying figures are an integral part of the multimedia-system specification, illustrating the solution provided by the invention and the multimedia-system functioning.

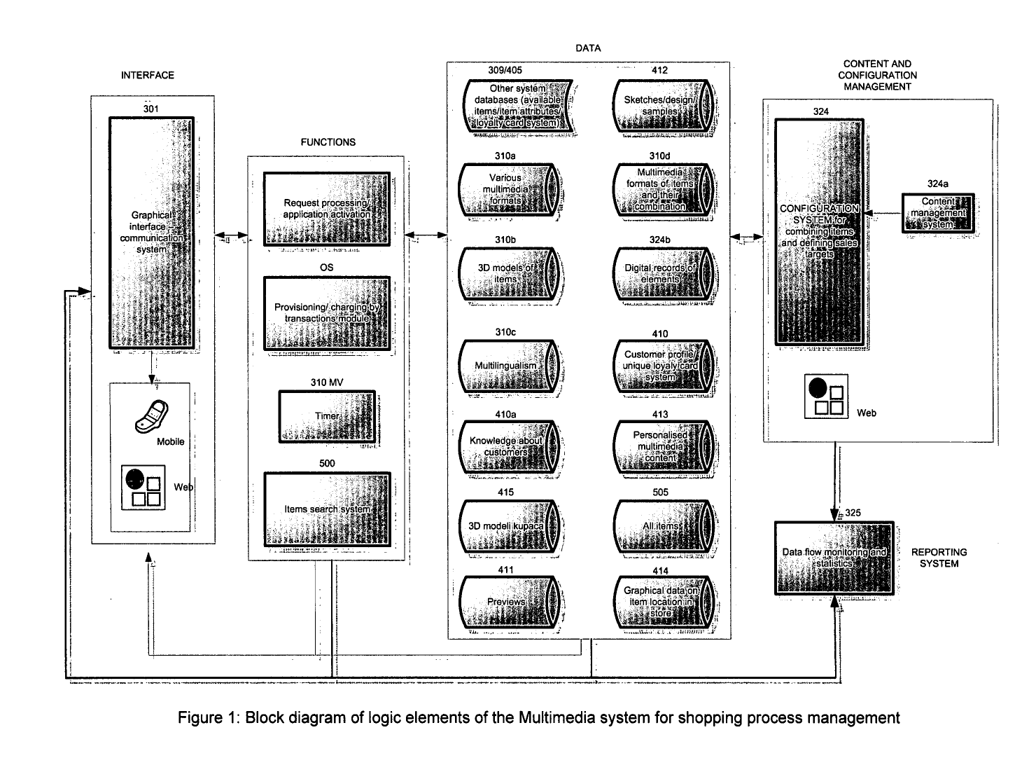

FIG. 1, sheet 1/6, presents a block diagram of logic elements of the multimedia-system for shopping process management, whose mutual interaction provides full functionality of the multimedia system.

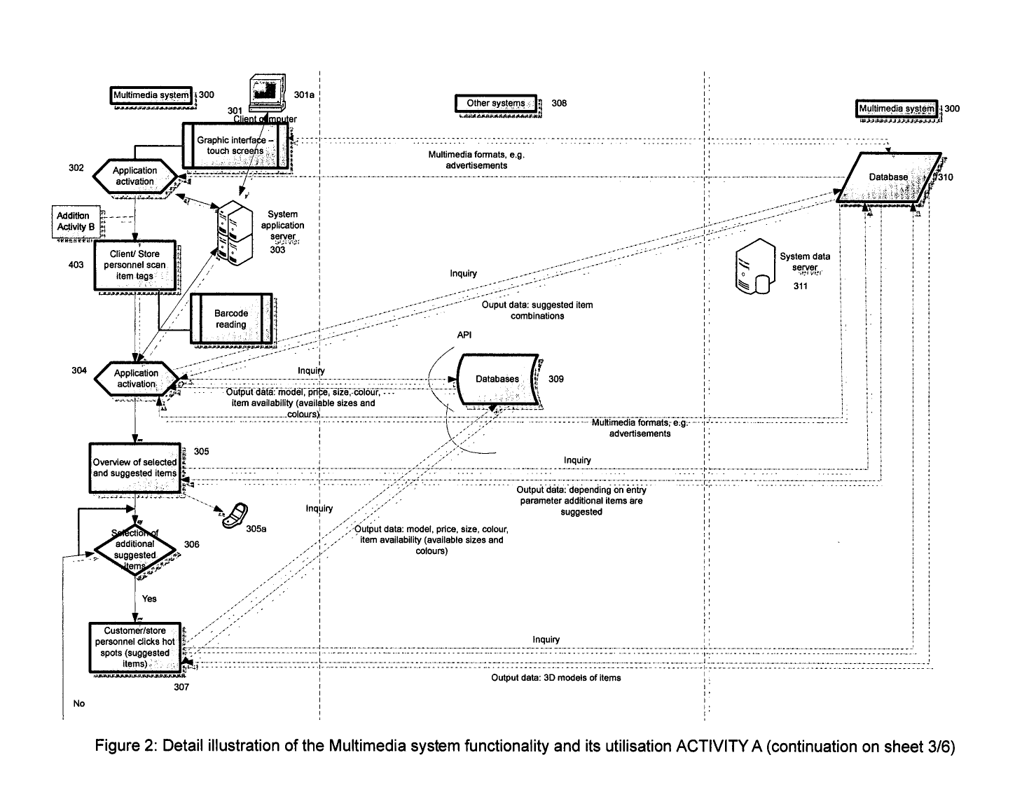

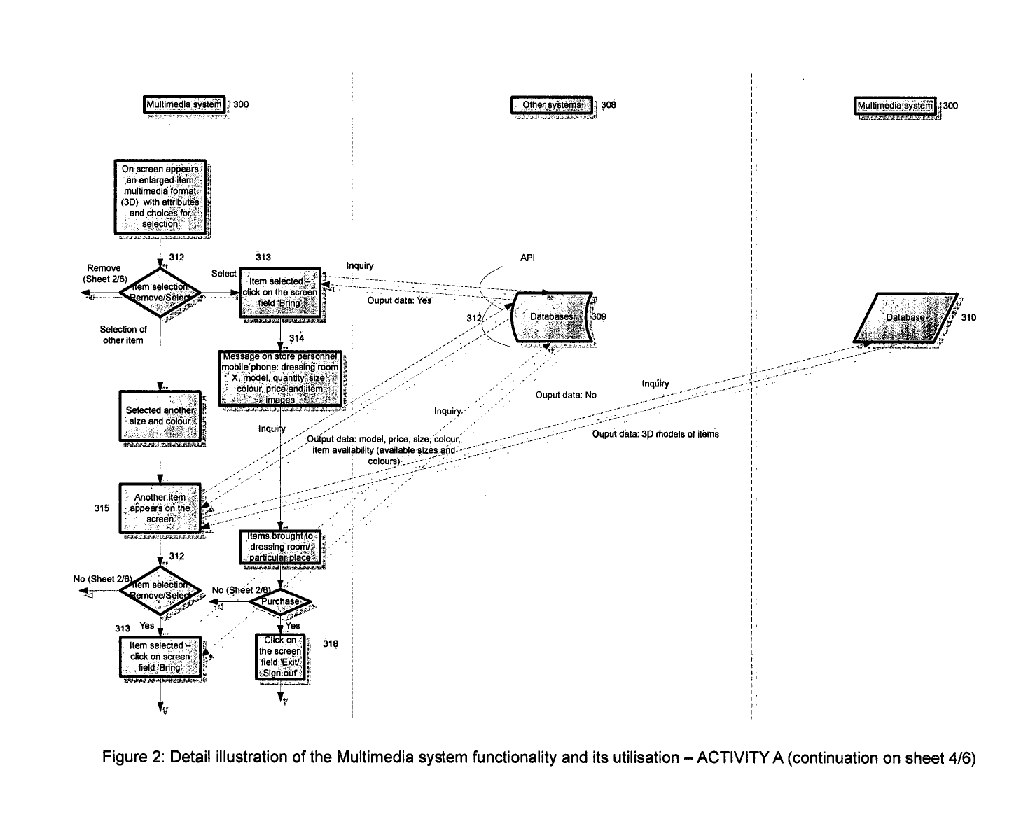

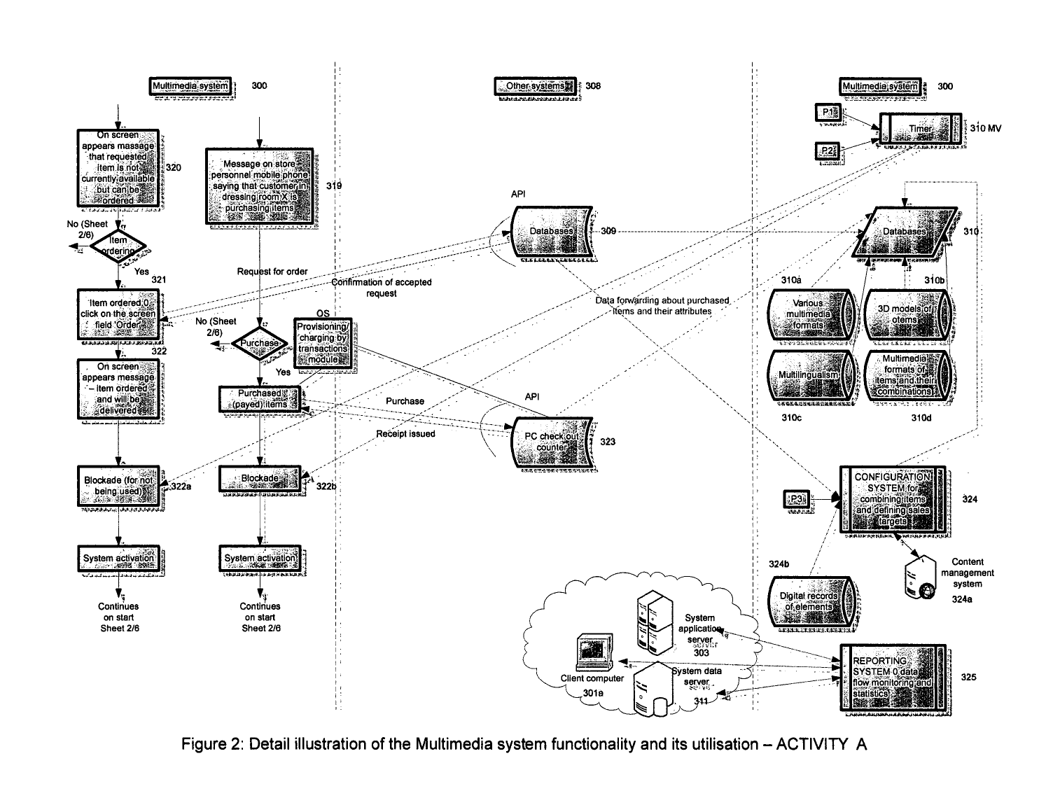

FIGS. 2, 3 and 4 show detailed presentations of the multimedia-system functioning by implementation activities.

FIG. 2, sheets 2/6, 3/6 and 4/6, present in detail the multimedia-system functionality and illustrate its utilisation methods in implementation of the ACTIVITY A: Suggesting additional sales items and transferring information/requests to the store personnel.

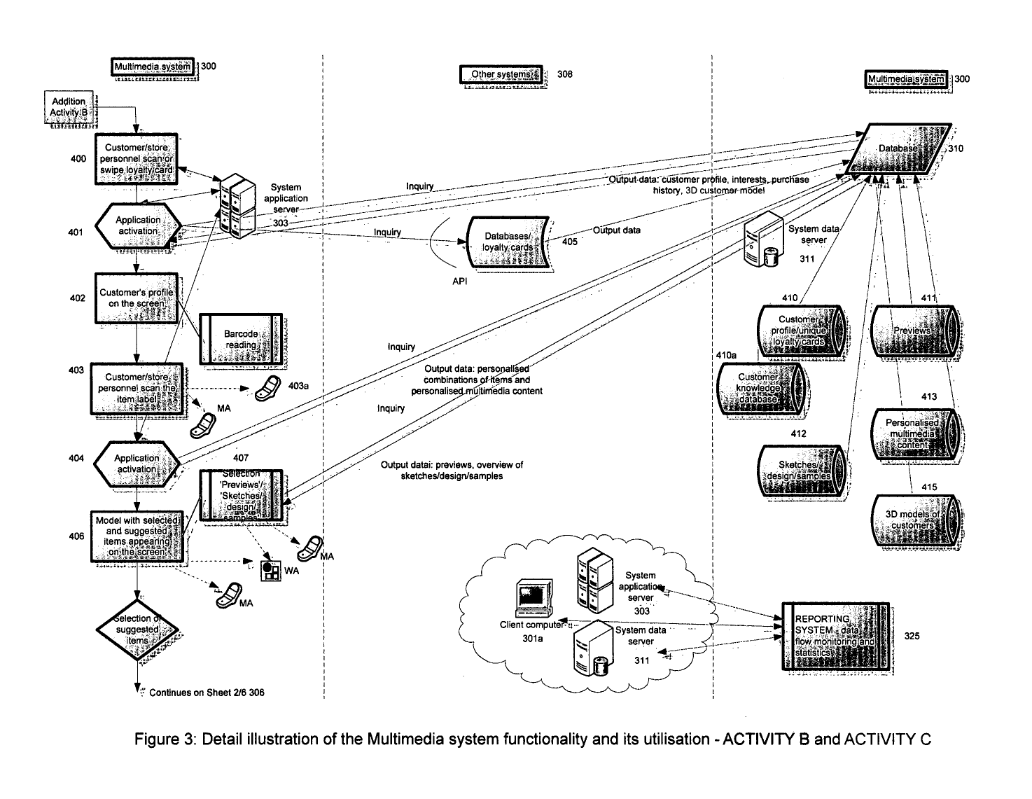

FIG. 3, sheet 5/6, presents the multimedia-system functionality in detail and illustrates its utilisation methods in implementation of the ACTIVITY B: Integration of loyalty cards with the multimedia system or introduction of unique loyalty cards system intended exclusively for the multimedia system, and implementation of the ACTIVITY C: Introduction of the customer 3D models.

FIG. 4, sheet 6/6, presents in detail the functionality of the Items Search System in implementation of the ACTIVITY B: Integration of the loyalty cards with the multimedia system or introduction of unique loyalty cards intended exclusively for the multimedia system.

The term ‘Other systems’ on all Figures refers to existing i.e. legacy IT—information technology systems in stores or retail chains.

### 6. DETAILED DESCRIPTION OF THE INVENTION EMBODIMENT

The Multimedia system for shopping process management 300 is presented in the FIG. 1, sheet 1/6, through the following logic elements:
INTERFACE—graphical interface 301 inside the store, linked with the web and mobile applications, and other application programming interfaces;
FUNCTIONS—such as request processing/application activation, provisioning/charging by transactions module OS, timer 310 MV, and items search system 500;
DATA—comprising various databases presented on the FIG. 1: item attributes 309, loyalty cards system 405, various multimedia formats 310a, 3D models of items 310b, multilingualism 310c, knowledge about customers 410a, 3D models of customers 415, collections preview 411, available items 309/405, multimedia formats of items and their combinations 310d, digital records of elements 324b, customer profile/unique loyalty card system 410, personalised multimedia content 413, all items 505, and overview of sketches/design/samples 412;
CONTENT and CONFIGURATION MANAGEMENT—configuration system 324 (for combining items and defining sales targets) and content management system 324a for data input linked with web services; and
REPORTING SYSTEM—data flow monitoring and statistics 325.

The multimedia system is implemented through the following activities:

ACTIVITY A—suggesting additional items and transferring information/requests to store personnel, to include:
reading the barcode/RFID of the in-store selected item. The item then appears on the screen in a multimedia format, including the item's attributes such as code, colour, size, and its combination with other suggested sales items;
initially selected and suggested items are specially marked as hot spots;
overview of other items best matching the selected one in terms of functionality, style, design, fabrics;
overview of suggested items, if selected they are shown on the screen as enlarged rotating 3D models or interactive images, alongside the item attributes such as the item code, colour, size, price;
transmitting suggested combinations retrieved on the screen on mobile phones via Bluetooth technology;
providing menu that enables selection of available sizes and colours;
sending a message to the store-personnel mobile device to bring additionally selected items to the customer in a particular dressing room or particular place in the store;
providing the possibility of ordering and subsequently delivering items that are not available;
data monitoring and statistics explained in following detail description of Activity A;
configuration of combinations of matching items and definition of sales targets; and
data input through the content management system.

ACTIVITY B—integration of a loyalty card system with the multimedia system 300 or introduction of unique loyalty card system intended for the multimedia system only, to include:
integration of an existing loyalty card system with the multimedia system 300 or introduction of special loyalty card system related to the multimedia system only;
reading the loyalty cards in store and identifying the loyalty card numbers through the multimedia system;
presenting the complete shopping history on the multimedia system screen;
reviewing and rating collections, making reservations and ordering in advance, before items arrive to the store;
gathering information about customers and their wishes;
evaluation of trends and styles of future collections by customers;
presenting video clips of items;
creating the Internet and mobile-phone customers community: mutual evaluation of style and suggestion of items, mutual help on purchase decisions, image or video capturing and transmitting via built in cameras in store if chosen by customer in store;
presenting items on the store-personnel mobile device, with its attributes: price, style, colour, size and video clips;
personalised styling for particular occasions, on demand;
Internet application enabling a complete insight into the customer's profile, habits, wishes, presentation of previous collections, previous and current orders;
new internal ordering system from shops to central warehouse linked with multimedia formats of items and their combinations based on sales history data and statistics
data monitoring and statistics explained in following detail description of Activity B;
configuration of combinations of matching items and definition of sales targets through the configuration system;
data input through the content management system; and
specific item search based on predefined parameters.

ACTIVITY C—introduction of the customer 3D models, to include:
introduction of the customers 3D model obtained from 3D laser scanning;
enabling customers to see garments on their 3D model;
entering customer's key measures and preferences in the multimedia system;
providing creation on demand and/or tailor made items;
Internet application enabling a complete insight into the customer's profile with his or her 3D model, habits, wishes, presentation of previous collections, previous and current purchases and orders; and
data flow monitoring and statistics system providing full functionality as described in Activity B.

Here follows a detailed description of the multimedia system 300 embodiment and functioning, and illustration of utilisation method by implementation activities:

Activity A—Suggesting Additional Items and Transferring Information/Requests to Store Personnel

The ACTIVITY A is presented in the block-diagram in FIG. 2, sheets 2/6, 3/6 and 4/6, implemented through the following elements: multimedia system front end and multimedia system back end (content and configuration management system and data flow monitoring and statistics—reporting system).

### The Multimedia System Front End

Touch-screens 301 are placed on tables and walls inside stores and inside dressing rooms in stores.

Barcode/RFID readers and Bluetooth transmitters are placed immediately next or under the touch-screen. Furthermore, client computers 301a are placed next to the touch-screens. The multimedia system 300 is activated by touching the screen or by reading the RFID code or the barcode of the item.

When the multimedia system is not activated, the screen 302 is used for presenting multimedia formats. In this case, the client computer 301a communicates with the multimedia-system application server 303, through which the application for multimedia content exchange 302 is activated, to exchange the multimedia content received from the multimedia-system databases 310a various multimedia formats.

The avatar communicates with the customers providing them advices on using the multimedia system or these advices are provided by the store personnel. A message also appears on the screen showing that through scanning the item labels/tags the multimedia system extracts other items matching the selected ones. After scanning or reading the selected item's label/tag, an inquiry is activated via the interface to the other system databases 309.

Through reading the barcode or RFID of the item label the communication between the multimedia system 300 and the database 310 is activated. The client computer 301a communicates with the application server of the system 303, through which the application for suggesting additional sales items 304 is activated. The multimedia system 300 communicates with the database 310, whereupon and depending on sent inquiries; pre-defined combinations of items are obtained from the database multimedia formats of items and their combinations 310d. Attributes of certain items appear on the multimedia system screen, such as: code, price: size, colour and their current availability in store and warehouse stocks.

The chosen items are presented on the screen, combined with other items best matching these, given the defined style, design, material, store's or retail chain's business targets. The initially selected and suggested items are particularly marked as hot spots on the screen to attract customers' attention. Additional items are presented on the screen depending on pre-defined item styles and combinations in the system.

By touching the suggested items on the screen customers/store personnel can see enlarged 3D model of items or their interactive images/video clips. Also a menu appears enabling a selection of (available) sizes, and colours. Via API-application programming interface, the multimedia system sends inquiries to databases of the other systems 309, which provides information on items with their attributes (model code, price, colour, size and availability). The multimedia system also sends the inquiry to the database 310 from which 3D models of items 310b and/or multimedia formats of items 310d are obtained.

It is also possible to select both the initial and the suggested items in other colours and sizes if available, because updated data on availability of sales items are obtained from the other system databases 309.

All additionally selected items accepted by pressing the field ‘Select’ 312 are shown on the screen. The multimedia system shows all the selected items the customer is interested in, and these may be changed by pressing the field ‘Remove’. If customers wish to receive items, they press the screen field ‘Bring’ 313.

Customers may receive suggested combinations to their mobile phone devices 305a through the Bluetooth technology. The store personnel receive on their mobile device the information on the customers' requests and the items that are to be taken to them to the requested place 314. Communication between the multimedia system and the mobile device is established through the telecommunication operator's network or through an internal communication system i.e. wireless communication system. The information on the requested item sent to the store personnel's mobile device includes the item's code, size, colour, price, and image.

The multimedia system is integrated with the store's IT-information technology system (indirectly also with the retail chain's central IT system) and checks the availability of items in terms of sizes, colours, model codes, etc. in store. If the selected items are not available, a message appears on the screen advising customers that items may be ordered 320. In this case, the multimedia system 300 sends information to the other systems 308 i.e. 309 notifying the store personnel.

Depending on the requests defined, the multimedia system may be customised to show or not to show items currently not available. If showing items currently not available, the multimedia system also offers the option of ordering unavailable items and having them sent to the store or the customers address, by pressing the field ‘Order’ 321.

Once the requested items have been presented to customers they can decide what to buy, by pressing the screen field ‘Exit/Sign out’ 318, the multimedia system transfers the data to the store PC check-out counter 323, which automatically tracks the sales generated through the multimedia system front end. If the customers change their mind at the point of sale and decide not to buy all items registered by the ‘Exit/Sign out’ field, the PC check-out counter updates the data received from the multimedia system front end, tracks the actual sale and sends data on the items sold to other system databases 309 and the multimedia system database 310. It is possible to additionally charge per transaction for all items purchased through the multimedia system. The charging per transaction is determined through the algorithm defined in the provisioning/charging by transactions module OS, which receives the information about transaction from the PC check-out counter 323.

A timer 310 MV is integrated with the multimedia system, so that the multimedia system is blocked 322b, depending on the entered defined parameter P1 for the blockage duration and the period of activation and cancellation of the blockade. The multimedia system is blocked for the purpose of a precise data transfer from the multimedia system 300 into other systems 308, especially the other system' PC check-out counter 323, before the multimedia system is used again. While the multimedia system is blocked, only the application for the multimedia content exchange remains active, without any other multimedia system functionalities. When the multimedia system front end is not being used for a certain period, according to the pre-defined time entered through the parameter P2, the multimedia system blocks itself for not being used 322a, where only the application for the multimedia content exchange remains active, without any other multimedia system 300 functionalities.

### The Multimedia-System Back End

a) Content and Configuration Management System

A part of the back end of the multimedia system 300, ‘Configuration System’ 324 for combining items and defining sale targets, is intended for direct usage by the store personnel, having a function of the configuration system for creating and building certain combinations of items offered to customers.

The sales items data are entered in the multimedia system directly through the content management system 324a or retrieved from other system databases 309.

The attributes that follow input of an item's data in the system are defined by classes and categories such as the group of products, code, colour, size, image, 3D model or video clip. Those attributes are relevant for certain item category. Items are combined and presented according to a priority criteria defined in database 310d.

Based on input items and their data, the store personnel builds combinations, i.e., configures various combinations of items according to the pre-defined style characteristic for given store, current trends and business and sales targets of a particular retail chain or store, defining which products, collections and combinations will be offered in a determined period of time, increasing the sales potential of particular items.

Based on input data, the multimedia system 300 generates database of item multimedia formats and their combinations 310d retrieved upon request for suggesting additional items for presentation on touch screen 305.

Creating combinations is related to one item and is limited by the pre-defined level parameter P3, therefore building an unlimited number of combinations and relating them to an item is not possible.

b) System Data Flow Monitoring and Statistics—Reporting System

Data flow monitoring and statistics are generated based on the communication between the client computer 301a, the system application server 303 and the system data server 311. Data flow monitoring and statistics system 325, intended for data flow monitoring and data exchange between the front end and the back end of the multimedia system, other systems, statistics tracking and data reporting:
visual overview of all the items sold and registered through the multimedia system defined by style, colour, size, price, groups or items and other attributes;
overview of all items viewed and selected through the multimedia system;
overview of all items sought and selected, but eventually not bought;
tracking a number of items sold in a transaction, additional sales in a transaction, and an increase in number of UPT—Units Per Transaction purchased through the multimedia system.
   Activity B—Integration of the Loyalty Cards with the Multimedia System or Introduction of Unique Loyalty Cards Intended Exclusively for the Multimedia System

ACTIVITY B and ACTIVITY C are presented in the block diagram, FIG. 3, sheets 5/6 and 6/6, implemented through the following elements: multimedia system front end, multimedia system back end (content and configuration management system and data flow monitoring and statistics—reporting system) and items search system.

### The Multimedia-System Front End

The multimedia system front end Activity B has upgraded functionalities of the multimedia system front end implemented in scope of Activity A.

The multimedia system 300 is activated by touching the touch-screen or reading the loyalty cards 400. The loyalty card number, registered on the customer mobile phone, may be read from the customer's personal mobile device through NFC (Near Field Communication) or Bluetooth technologies.

While the multimedia system is not active, the screens 302 are used for presenting multimedia formats. In this case, the client computer 301a communicates with the system application server 303, through which the application 404 for exchange of the personalised multimedia content received from the multimedia system database 310a is activated.

Through reading the loyalty card with the reader or entering the loyalty card number on the screen the communication between the client computer 301a and the system application server 303 is activated, as shown in the FIG. 3, which activates the application 401 for loyalty card as an upgrade of the ACTIVITY A, hereafter referred to as ‘Addition Activity B’ in the FIG. 3.

In the case of an existing loyalty card system 405, the one is integrated with the multimedia system in a way that multimedia system sends an inquiry to other system databases 405 and retrieves necessary data in the customer profile 410. Depending on an inquiry sent to the multimedia system 300 database, suggested items 406 together with initially selected are presented on screen. A summary of the customer's profile 410 is also presented and the personalised multimedia content 413 is generated. Depending on customers' pre-defined interests and previous sales, the multimedia system provides a personalised suggestion of additional sales items 406.

When the unique loyalty card system 405 is introduced, communication between the multimedia system 300 and the multimedia system database 310 is activated. Depending on an inquiry, the customer-profile data are received from the database ‘Customer Profile/Loyalty Cards’ 410, related to the loyalty card number. The profile summary contains information such as pre-defined customers' interests, colours, models of interest, shopping history, reservations, etc. Depending on pre-defined customers' interests and previous sales, the multimedia system provides a personalised suggestion of additional items 406. Also depending on customers' interests stated in the profile 410, the multimedia system retrieves certain personalised multimedia content 413.

Customers may receive suggested combinations on their e-mail and/or mobile device MA or can see them in the customer's profile through the Internet application WA, and/or can see them when they visit the store next time, unless the items are bought. Customers can access their profile through the Internet application WA, mobile device MA or through the multimedia system in the store, and check their wishes, shopping and orders history. The store personnel receives customers' information and their preferences, wishes, and shopping history 403, to their mobile device MA (if the customer loyalty card number is transferred via NTF or Bluetooth technologies to the store personnel mobile phone) and/or by direct use of the multimedia system 300 in order to provide a fast and efficient service at the point of shopping.

The store personnel uses a mobile device that can scan an item's label/tag to receive the information on its price, style, size, and to present video clips related to selected and scanned item, which can be shown to customer directly 403a.

By reading the loyalty card 410a the customer's entire shopping history is presented on the multimedia system 300 screen, the Internet application WA or the mobile application MA. Based on the customer's shopping history and pre-defined interests, certain items are suggested in a personalised way. Through the Internet application for administration and customer review WA, the customers define their profile, interests and wishes. The application also contains an interactive questionnaire: learning about customers and their wishes through their rating and selection of trends and styles for future collections.

Through touching the screen field ‘Previews’ 407 on the multimedia system screen in the store, communication between the multimedia system and the database 310 is activated. Based on that inquiry previews (pre-collections) are retrieved from database ‘Previews’ 411. It is also possible to retrieve the same data through the Internet application WA and mobile application MA. The collections may be rated, reserved and ordered in advance, before items of interest arrive to store.

Touching the screen field ‘Samples’ 407 on the screen 302 activates communication between the multimedia system 300 and the database 310. Based on those inquiry overviews of drawings, design, and sample are retrieved from the ‘Drawings/Design/Samples’ database 412. It is also possible to retrieve the same data through the Internet application WA and mobile application MA. This way the customers directly influence the development of future collections.

If customers choose to receive interesting information ‘on demand’, having the possibility to subscribe to this mobile and/or web service for pre-defined period of time, they receive the suggested combinations of items for various occasions, both via Internet application WA and/or mobile application MA on their mobile phone device.

Creation of Internet and mobile-phone customers' community:

A customer defines members of his/her community through the Internet application WA and/or the mobile-phone application MA, allowing thereby access to specific information.

The community members may exchange information on their preferences, wishes, rate certain items and give opinions how they fit to particular members, and suggest items.

The customer's mobile device communicates with the customers' community pre-defined with the customers profile, so that they can share the item information and images while customer is still in the store. Images are transmitted via built in cameras so members of the customer community can see how items fit their friends in store/dressing room if chosen by customers in store, in order to help them make decisions.

Identifying the location:

Members of the friends/customers mobile-phone community who approved this service are informed that their friend is in store if they are close to that store and the multimedia system 300 invites them to come to store and help with deciding on the purchase.

### The Multimedia System Back End

a) Content and Configuration Management System

The multimedia system back end—Content and Configuration Management System has the same functionality as described in Activity A.

b) System Data Flow Monitoring and Statistics—Reporting System

Data flow monitoring and statistics are generated based on the communication between the client computer 301a, the system application server 303 and the system data server 311 of the multimedia system 300.

This part of the multimedia system shown on the FIG. 3, Page 5/6 has upgraded functionality in relation to the part of the multimedia system ‘System Data flow monitoring and statistics system’ 325, implemented in the ACTIVITY A. It is intended for data flow monitoring and exchange between the front end and the back end of the multimedia system, other systems, and statistics tracking and data reporting:
visual review of all items sold and registered through the multimedia system and defined by style, colour, size, groups of items and other attributes;
overview of all items viewed through the multimedia system;
overview of items sought and selected, but eventually not bought;
tracking a number of items sold in a transaction, additional sales in a transaction, and an increase in number of UPT—Units Per Transaction purchased through the multimedia system;
data gathering useful for ordering and creating new items and collections based on the statistics regarding sold items, sales follow up, request history, presentation of pre-collections, samples, etc.;
monitoring all purchases made through the multimedia system, customers' requests and missed opportunities;
reporting by predefined criteria;
gathering the complete knowledge of loyal customers' wishes and interests;
gathering all data related with items search system (input parameters, output results, store, etc.); and
statistics generation and reporting.

### Item Search System

### FIG. 4, Sheet 6/6: Activity B—Item Search System

The in-the-store or Internet item search application 502 is activated by communication between the client computer 301a and the application server 303 of the multimedia system 300.

Based on input parameters 501 specific for the searched item, such as style, colour and size, and other parameters entered on the screen in store or the Internet application, the item search application 502 is activated. The multimedia system sends an inquiry to the other systems databases 310, which extracts, in the view mode, all the items meeting defined searched item's parameters 503. All items stored in all items database 505 and the other system databases 309 are indexed, i.e., uniquely marked and sorted by the pre-defined indexed value parameters 505a, which enable their fast retrieval and presentation in view mode.

The multimedia system also sends inquiry to the multimedia system database 310, which contains multimedia formats of items and the graphic presentation on item location in store 414, whereupon, depending on the inquiry, the requested information is presented 503 on touch screen. The item's image and/or video clip as well as other attributes such as model code, colour, size, availability, and the graphical information explaining where items are located in store or shopping mall 414, are all presented in the view mode, so that customers may quickly find the searched item 503.

### Activity C: Introduction of the Customer 3D Models

ACTIVITY B and ACTIVITY C—Shown in the block diagram FIG. 3, sheet 5/6, implemented through the following elements: multimedia system front end and multimedia system back end (content and configuration management system and data flow monitoring and statistics—reporting system).

### The Multimedia System Front End

Through entering the loyalty card number on the multimedia system touch screen or scanning the loyalty card with the reader the communication between the client computer 301a and the application server 303 of the multimedia system 300 is activated which, in turn, activates the loyalty card application.

The loyalty card number, registered on the customer mobile phone may be read from the customer's personal mobile device through NFC (Near Field Communication) or Bluetooth technologies.

When a loyalty card system already exists, it is integrated with the multimedia system in the way that it sends inquiry to the other system databases 405 from where it obtains the required customer profile information. The 3D customer model is retrieved from the 415 database and presented on screen with the initially selected and suggested items retrieved from 410a database. Personalised multimedia content is retrieved from database 413 and presented as well.

When unique loyalty card system is introduced, using the reader or entering the loyalty card number on the touch screen, the communication between the client computer 302a and the multimedia system application server 303 in activated, which, in turn, activates the loyalty card application 401. Communication between the multimedia system 300 and the database 310 is activated, and upon inquiry, the customer profile information is obtained from the database ‘Customer Profile/Loyalty Card’ 410 containing data such as the customer's pre-defined interests, colours, models of interest, shopping and reservations history, etc. Depending on customers' pre-defined interests and previous sales, the multimedia system generates a personalised suggestion of additional sales items 402. Also depending on customers' pre-defined interests stated in their profile, the multimedia system presents certain personalised multimedia content 413. By embedding the customer's 3D model into the multimedia system customers can see garments and suggested combinations on their 3D models.

The multimedia system records the customers key measurements based on 3D model, preferences and wishes, enabling a fully personalised approach. The multimedia system provides the most benefits if it is implemented by vertically integrated retailers and integrated with the existing IT—information technology system. In that case certain items can be on demand and/or tailor made, which significantly enhances the operative efficiency and decreases the merchandise warehouse requirements.

### The Multimedia System Back End

a) Content and Configuration Management System

The multimedia system back end—Content and Configuration Management System has the same functionality as described in Activity A.

b) Data Flow Monitoring and Statistics System

The multimedia system back end—Data Flow Monitoring and Statistics System provides full functionality as described in Activity B.

### Advantages of Introducing the Multimedia System for Shopping Process Management

Advantages for retailers applying the multimedia system for shopping process management:
better presentation of sales items that are not readily noticeable or available;
boost of sales through generating additional sales;
targeted personalised approach;
enhanced brand awareness and loyalty;
fast response to customer demands;
better prediction of customer behaviour;
better segmentation of the customer target groups and their interests;
improvement of the existing IT—information technology system;
targeted ordering, possibility of seeing/reserving/ordering the collections in advance;
assistance in searching for items and combining them with other items;
faster and more efficient engagement of the store personnel;
unique and entertaining shopping experience;
creating the customers Internet and mobile communities providing services such as exchange ideas, experiences and recommendations among customers;
privacy in searching and selecting items;
participation in creating new items;
presentation of enlarged rotating 3D models or interactive images/video clips; and
sophisticated statistics and specific data gathering.

### BRIEF DEFINITION OF THE REFERENCE MARKS USED IN DOCUMENT AND FIGURES

300—multimedia system for shopping process management (i.e. multimedia system)
301—graphic user interface
301a—client computer
302—activation of the application for multimedia content exchange
303—system application server
304—activation of the application for additional items suggesting
305—overview of selected and suggested items
305a—mobile device (mobile phone/smart phone)
306—possibility of selecting the suggested items
307—customer/store personnel clicks the suggested item on the screen
308—other systems
309—other systems databases
309/405—available sales items/item attributes/loyalty card system
310 MV—timer
310—database
310a—various multimedia formats
310b—3D models of items
310c—multilingualism
310d—multimedia formats of items and their combinations
311—system data server
312—‘Select/Remove” item selection screen field
313—‘Bring’ screen field
314—store personnel receive on their mobile device a message to bring requested items to dressing room X (or particular place in store): model code, quantity, size, colour, price, and image
315—another item appearing on the screen
318—‘Exit/Sign Out’ screen field
319—store personnel receive on their mobile device message that the customer in the dressing room X is buying certain items
320—message appears on the screen saying that the requested item is not on the stock but can be ordered
321—‘Order’ screen field
322—message appears on the screen saying that the item has been ordered and will be delivered
322a—system blockade (for not being used)
322b—system blockade
323—PC check-out counter
324—configuration system for combining items and defining sales targets
324a—content management system
324b—digital records of elements
325—data flow monitoring and statistics
400—customer/store personnel scan/swipe loyalty card or enter loyalty card number/reading the card number via NFC or Bluetooth technologies
401—activation of the loyalty card application
402—view of the customer's profile
403—customer/store personnel scan items' labels/tags
403a—scanned items can be presented to customers on the store personnel mobile phones
404—activation of the application for personalised multimedia content exchange
405—other systems database—loyalty card system
406—model with selected and suggested items appearing on the screen
407—‘Previews’/‘Sketches/design/samples” selection screen field
410—customer profile/unique loyalty card system
410a—customer knowledge database
411—previews database
412—sketches/designs/samples database
413—personalised multimedia content database
414—graphic data on item location in store database
415—customer 3D models database
500—item search system
501—entering parameters on screen or Internet application
502—activation of the item search system application
503—presentation of the requested items
505—all items
505a—index values
OS—provisioning/charging by transactions module
WA—Web (Internet) application
MA—mobile application
P1—blockade duration parameter
P2—time parameter
P3—combinations level parameter
API—application programming interface
3D—three dimensional formats
IT—information technology.

### 7. INVENTION APPLICATION

The multimedia system for shopping process management is applicable for various retail chains, i.e., vertically integrated corporations (integrated production, procurement and sales) and stores, whereas the multimedia system's end users are customers/shoppers.

The multimedia system is particularly beneficial for vertically integrated corporations because it enhances their internal ordering system through a direct access to all information collected in pre-sales and sales cycles.

This invention can be applicable for various retail chains and stores regardless of sales items kind and functionality.

The multimedia system introduction concept has two approaches:

### 1. Approach Towards Mid-Class Retailers:

Retailers of this sort don't offer personalised approach. The store personnel are very poorly included in the active sales process. At the end, customers are left alone, with no assistance in finding an item and its adequate combinations, feedback on how something fits them, etc., which creates a room for introduction of this multimedia system.

### 2. Approach Towards High-Class Retailers:

Retailers of this sort want to emphasize personalised approach, but still, in some situations, the store personnel are unable to provide such service. For instance, occasionally there are several customers in store at the same time, and the store personnel cannot pay attention to all of them, or occasionally the personnel is not acquainted with all items in store and their adequate combinations to be offered. Hence certain opportunities are being missed, that can be avoided by introducing this multimedia system.

1-10. (canceled)

11. An interactive personal shopping management system for individualized shopping support over at least one communications network, the interactive personal shopping management system comprising:
at least one customer interface terminal having a product identification code reader;
a database operatively coupled to the at least one customer interface terminal configured to maintain a plurality of product identifiers and customer information;
at least one portable store-personnel device accessible over the at least one communications network;
a computer program product operatively coupled to the customer interface terminal, the computer program product having a computer-usable medium having a sequence of instructions which, when executed by a processor, causes said processor to execute a process that provides individualized shopping support, the process comprising:
reading a product identification code of a product, wherein the product identification code corresponds to identifying attributes of the product;
recommending other suggested products based on the identifying attributes of the product;
displaying a graphical representation of the product and the other suggested products at the customer interface terminal, the graphical representation of the product highlighting the product and other suggested items;
receiving an electronic request to select at least one of the other suggested products, wherein the electronic request includes identifying attributes for each of the other suggested products; and
transmitting the electronic request to the at least one portable store-personnel device.

12. The interactive personal shopping management system of claim 1, wherein recommending other suggested products is further based on a set of pre-defined combinations that include the product, and wherein the set of pre-defined combinations is maintained in the database.

13. The interactive personal shopping management system of claim 1, wherein the graphical representation of the product includes a 3D-model of the product.

14. The interactive personal shopping management system of claim 1, wherein identifying attributes of the product are selected from the group comprising: (1) model code, (2) color, (3) size, (4) price, (5) material, (6) body type match; and (7) availability.

15. The interactive personal shopping management system of claim 1, wherein the product identification code is a barcode.

16. The interactive personal shopping management system of claim 1, wherein the product identification code is a radio-frequency identification (RFID) tag.

17. The interactive personal shopping management system of claim 1, further comprising an inventory server accessible over the at least one communications network, wherein the process further comprises checking availability of the other suggested products; determining a set of unavailable suggested products based on availability; and placing an order for unavailable suggested products over the at least one communications network to the inventory server.

18. The interactive personal shopping management system of claim 1, wherein the customer interface terminal further includes location information of the customer interface terminal, and wherein the electronic request further includes the location information.

19. An interactive personal shopping management system for individualized shopping support over at least one communications network, the interactive personal shopping management system comprising:
at least one customer interface terminal having a product identification code reader and a customer loyalty card reader;
a database operatively coupled to the at least one customer interface terminal configured to maintain a plurality of product identifiers and customer information;
at least one portable store-personnel device accessible over the at least one communications network;
a computer program product operatively coupled to the customer interface terminal, the computer program product having a computer-usable medium having a sequence of instructions which, when executed by a processor, causes said processor to execute a process that provides individualized shopping support, the process comprising:
reading a customer loyalty card, the customer loyalty card being mapped to the customer information, wherein the customer information uniquely identifies a consumer user and order history stored in the database;
reading a product identification code of a product, wherein the product identification code corresponds to identifying attributes of the product;
recommending other suggested products based on the identifying attributes of the product and the customer information identified by the customer loyalty card;
displaying a graphical representation of the product and the other suggested products at the customer interface terminal, the graphical representation of the product highlighting the product and other suggested items;
receiving an electronic request to select at least one of the other suggested products, wherein the electronic request includes identifying attributes for each of the other suggested products;
storing the request in the customer information for the consumer user in the database; and
transmitting the electronic request to the at least one portable store-personnel device.

20. The interactive personal shopping management system of claim 9, wherein the customer loyalty card is stored on an electronic consumer device.

21. The interactive personal shopping management system of claim 9, wherein the customer loyalty card further defines a community of other consumer users of the consumer user.

22. The interactive personal shopping management system of claim 11, wherein the other suggested products are also based on the community of other consumer users of the consumer user.

23. The interactive personal shopping management system of claim 9, wherein the customer information further includes information selected from the group comprising: (1) a size of the consumer user; (2) physical characteristics of the consumer user; (3) budget; and (4) product preferences.

24. An interactive personal shopping management system for individualized shopping support over at least one communications network, the interactive personal shopping management system comprising:
at least one customer interface terminal having a product identification code reader;
a database operatively coupled to the at least one customer interface terminal configured to maintain a plurality of product identifiers and customer information;
at least one portable store-personnel device accessible over the at least one communications network;
a computer program product operatively coupled to the customer interface terminal, the computer program product having a computer-usable medium having a sequence of instructions which, when executed by a processor, causes said processor to execute a process that provides individualized shopping support, the process comprising:
receiving a graphical 3D model of a consumer user;
reading a product identification code of a product, wherein the product identification code includes identifying attributes of the product and other suggested products, wherein the other suggested products are based on a set of pre-defined combinations including the product maintained in the database; and
displaying a graphical representation of the product and the other suggested products on the graphical 3D model of the consumer user at the customer interface terminal, the graphical representation of the product highlighting the product and other suggested items.

25. The interactive personal shopping management system of claim 14, wherein the process further comprises receiving an electronic request to select at least one of the other suggested products, wherein the electronic request includes identifying attributes for each of the other suggested products.

26. The interactive personal shopping management system of claim 14, wherein the process further comprises transmitting the electronic request to the at least one portable store-personnel device.

27. The interactive personal shopping management system of claim 14, wherein receiving a graphical 3D model of a consumer user further comprises laser scanning a consumer user to mathematically transform the consumer's body into the 3D model.

28. The interactive personal shopping management system of claim 17, wherein the process further comprises storing the graphical 3D model of the consumer user in the database mapped to the consumer user.

29. The interactive personal shopping management system of claim 14, wherein the at least one customer interface terminal further includes a customer loyalty card reader, and the step of receiving a graphical 3D model of a consumer user further comprises reading a customer loyalty card, the customer loyalty card uniquely identifying a consumer user, order history, and a 3D model of the consumer user in the database.

30. The interactive personal shopping management system of claim 14, wherein the product identification code is a barcode.

31. The interactive personal shopping management system of claim 14, wherein the product identification code is a radio-frequency identification (RFID) tag.

32. The interactive personal shopping management system of claim 14, further comprising an inventory server accessible over the at least one communications network, wherein the process further comprises checking availability of the other suggested products; determining a set of unavailable suggested products based on availability; and placing an order for unavailable suggested products over the at least one communications network to the inventory server.
